(19) United States
(12) Patent Application Publication
(10) Pub. No.: US 2024/0397307 A1
(43) Pub. Date: Nov. 28, 2024

(54) TERMINAL CAPABILITY REPORTING METHOD AND APPARATUS, AND STORAGE MEDIUM

(71) Applicant: Beijing Xiaomi Mobile Software Co., Ltd., Beijing (CN)

(72) Inventors: Shengxiang GUO, Beijing (CN); Xueyuan GAO, Beijing (CN)

(21) Appl. No.: 18/695,180

(22) PCT Filed: Sep. 29, 2021
(86) PCT No.: PCT/CN2021/121716

§ 371 Date: Mar. 25, 2024

(51) Int. Cl. H04W 8/22; H04B 7/06; H04L 5/00

(52) U.S. Cl. CPC H04W 8/22; H04B 7/0602; H04L 5/0051

(57) ABSTRACT

A method for reporting a terminal capability is performed by a terminal, and includes: reporting capability information of the terminal to a network side device, wherein the capability information includes a maximum number of transmitted layers being greater than two and an antenna switching capability.

### CROSS REFERENCE TO RELATED APPLICATIONS

The present disclosure is the U.S. national phase application of International Application No. PCT/CN2021/121716 filed on Sep. 29, 2021, the content of which is incorporated herein by reference in its entirety.

### TECHNICAL FIELD

The present disclosure relates to the field of communication technology, in particular to a method for reporting a terminal capability, an apparatus thereof and a storage medium.

### BACKGROUND

In the new radio (NR) system, a network side device is supported to obtain downlink channel information by means of the channel reciprocity to improve downlink data transmission performance. In order to support the network side device to effectively obtain downlink information by means of the channel reciprocity under various terminal transmission and reception capabilities, the NR system has specially designed a sounding reference signal (SRS).

### SUMMARY

In the first aspect, the present disclosure provides a method for reporting a terminal capability, which is performed by a terminal. The method includes: reporting capability information of the terminal to a network side device. The capability information includes a maximum number of transmitted layers being greater than two and an antenna switching capability.

In the second aspect, the present disclosure provides a method for reporting a terminal capability, which is performed by a network side device. The method includes: receiving capability information reported by a terminal. The capability information includes a maximum number of transmitted layers being greater than two and an antenna switching capability.

In the third aspect, embodiments of the present disclosure provide a communication apparatus. The communication apparatus can implement some or all of the functions of the terminal in the method described in the first aspect, for example, the functions of the communication apparatus have some or all of functions described in embodiments of the present disclosure, or can independently implement any one of the embodiments of the present disclosure. The functions described can be implemented through hardware or by executing corresponding software through hardware. The hardware or software includes one or more units or modules corresponding to the above functions.

In some embodiments, the communication apparatus can include a transceiver module and a processing module. The processing module is configured to support the communication apparatus in achieving the corresponding functions in the above methods. The transceiver module is configured to support the communication between the communication apparatus and other devices. The communication apparatus can further include a storage module for coupling with the transceiver module and the processing module. The storage module stores necessary computer programs and data for the communication apparatus.

In some embodiments, the communication apparatus includes a transceiver module configured to report capability information of a terminal to a network side device, and the capability information includes a maximum number of transmitted layers being greater than two and an antenna switching capability.

In the fourth aspect, embodiments of the present disclosure provide a communication apparatus. The communication apparatus can implement some or all of the functions of the network side device in the method described in the second aspect, for example, the functions of the communication apparatus have some or all of functions described in embodiments of the present disclosure, or can independently implement any one of the embodiments of the present disclosure. The functions described can be implemented through hardware or by executing corresponding software through hardware. The hardware or software includes one or more units or modules corresponding to the above functions.

In some embodiments, the communication apparatus can include a transceiver module and a processing module. The processing module is configured to support the communication apparatus in achieving the corresponding functions in the above methods. The transceiver module is configured to support the communication between the communication apparatus and other devices. The communication apparatus can further include a storage module for coupling with the transceiver module and the processing module. The storage module stores necessary computer programs and data for the communication apparatus.

In some embodiments, the processing module can be a processor, the transceiver module can be a transceiver or a communication interface, and the storage module can be a memory.

In some embodiments, the communication apparatus includes a transceiver module configured to receive capability information reported by a terminal, and the capability information includes a maximum number of transmitted layers being greater than two and an antenna switching capability.

In the fifth aspect, embodiments of the present disclosure provide a communication device including a processor, which causes the method described in the first aspect to be implemented when the processor calls a computer program in memory.

In the sixth aspect, embodiments of the present disclosure provide a communication device including a processor, which causes the method described in the second aspect to be implemented when the processor calls a computer program in memory.

In the seventh aspect, embodiments of the present disclosure provide a communication device including a processor and a memory for storing a computer program, wherein the processor is configured to execute the computer program stored in the memory to cause the method described in the first aspect to be implemented.

In the eighth aspect, embodiments of the present disclosure provide a communication device including a processor and a memory for storing a computer program, wherein the processor is configured to execute the computer program stored in the memory to cause the method described in the second aspect to be implemented.

In the ninth aspect, embodiments of the present disclosure provide a communication device including a processor and an interface circuit, wherein the interface circuit is configured to receive and transmit code instructions to the processor, and the processor is configured to run the code instructions to cause the method described in the first aspect to be implemented.

In the tenth aspect, embodiments of the present disclosure provide a communication device including a processor and an interface circuit, wherein the interface circuit is configured to receive and transmit code instructions to the processor, and the processor is configured to run the code instructions to cause the method described in the second aspect to be implemented.

In the eleventh aspect, embodiments of the present disclosure provide a communication system including the communication apparatus as described in the third aspect and the communication apparatus as described in the fourth aspect, or the system including the communication device as described in the fifth aspect and the communication device as described in the sixth aspect, or the system including the communication device as described in the seventh aspect and the communication device as described in the eighth aspect, or the system including the communication device as described in the ninth aspect and the communication device as described in the tenth aspect.

In the twelfth aspect, embodiments of the present disclosure provide a non-transitory computer-readable storage medium for storing instructions used for the terminal, which when executed cause the terminal to perform the method described in the first aspect.

In the thirteenth aspect, embodiments of the present disclosure provide a non-transitory computer-readable storage medium for storing instructions used for the network side device, which when executed cause the network side device to perform the method described in the second aspect.

In the fourteenth aspect, embodiments of the present disclosure provide a computer program product including a computer program, when the computer program is running on a computer, causes the computer to implement the method described in the first aspect.

In the fifteen aspect, embodiments of the present disclosure provide a computer program product including a computer program, when the computer program is running on a computer, causes the computer to implement the method described in the second aspect.

In the sixteenth aspect, the present disclosure provides a chip system including at least one processor and an interface for supporting a terminal in achieving the functions related to the first aspect, such as determining or processing at least one of the data and information involved in the above method. In some embodiments, the chip system further includes a memory for storing necessary computer programs and data for the terminal. The chip system can be composed of chips or include chips and other discrete devices.

In the seventeenth aspect, the present disclosure provides a chip system including at least one processor and an interface for supporting a network side device in achieving the functions related to the second aspect, such as determining or processing at least one of the data and information involved in the above method. In some embodiments, the chip system further includes memory for storing necessary computer programs and data for the network side device. The chip system can be composed of chips or include chips and other discrete devices.

In the eighteenth aspect, the present disclosure provides a computer program, which when is running on a computer, causes the computer to implement the method described in the first aspect.

In the nineteenth aspect, the present disclosure provides a computer program, which when is running on a computer, causes the computer to implement the method described in the second aspect.

### BRIEF DESCRIPTION OF THE DRAWINGS

The accompanying drawings of the present disclosure is briefly described below.

FIG. 1 is a diagram of an architecture of a communication system according to embodiments of the present disclosure;

FIG. 2 is a flowchart of a method for reporting a terminal capability according to embodiments of the present disclosure;

FIG. 3 is a flowchart of a method for reporting a terminal capability according to embodiments of the present disclosure;

FIG. 4 is a flowchart of a method for reporting a terminal capability according to embodiments of the present disclosure;

FIG. 5 is a flowchart of a method for reporting a terminal capability according to embodiments of the present disclosure;

FIG. 6 is a flowchart of a method for reporting a terminal capability according to embodiments of the present disclosure;

FIG. 7 is a flowchart of a method for reporting a terminal capability according to embodiments of the present disclosure;

FIG. 8 is a flowchart of a method for reporting a terminal capability according to embodiments of the present disclosure;

FIG. 9 is a flowchart of a method for reporting a terminal capability according to embodiments of the present disclosure;

FIG. 10 is a flowchart of a method for reporting a terminal capability according to embodiments of the present disclosure;

FIG. 11 is a diagram of a structure of a communication apparatus according to embodiments of the present disclosure;

FIG. 12 is a diagram of a structure of a communication device according to embodiments of the present disclosure; and

FIG. 13 is a schematic diagram of a structure of a chip according to embodiments of the present disclosure.

### DETAILED DESCRIPTION

For ease of understanding, the terms involved in the present disclosure will be introduced first in the following.

### 1. Radio Frequency (RF) Channel

The RF channel is also referred to as the RF link. The RF link in the uplink direction of the terminal can be referred to as the RF transmission link, and the RF link in the downlink direction of the terminal can be referred to as the RF receiving link. The baseband signal generated by the terminal in the baseband is transmitted on the RF transmission link through an antenna to generate the RF signal. Similarly, the terminal receives the signal on the RF receiving link through the antenna, and the signal received is then processed in the baseband. The RF link includes an RF transceiver circuit, a power amplifier, and a duplexer/filter. The terminal can access multiple network side devices and communicate with the multiple network side devices through multiple RF links. One RF link can correspond to one network side device. For example, the terminal can access two or four network side devices. The terminal can access the multiple network side devices through Dual-Connectivity (DC) or through Carrier Aggregation (CA). The RF link can be integrated in the RF chip, or the RF link can also be integrated with the baseband processing circuit in the same chip.

### 2. Port

The port is also referred to as the antenna port. On the network side, the RF link and the antenna can be abstracted as the port. When the terminal has N RF links, it means that the terminal can support the communication with the network side device using up to N ports simultaneously. For example, if N=2, the terminal has two RF links and supports communication with network side devices using up to two ports simultaneously. In the practical application, each RF link corresponds to one port. If the terminal uses one port to communicate with the network side device, the terminal can use any one of the two RF links to correspond to this port, or the terminal can simulate two RF links simultaneously to form one port, which depends on the specific implementation of the terminal side and is transparent to the network side device. The network side device only needs to schedule the terminal to send uplink signals on which port.

### 3. Antenna Capability

The antenna capability includes the number of ports, the number of layers, the number of RF links, the number of antennas, the maximum number of ports, the maximum number of layers, the maximum number of RF links, or the maximum number of antennas, etc. The number of layers refers to the number of signal streams uncorrelated to each other contained in the data for sending when the data for sending is pre-coded. For example, if a terminal uses four ports to send data, but sending the same or related data using these four ports, it can be understood that the terminal uses these four ports to send one stream of data, or in other words, sending one layer of data. For example, if the four ports include Port 0, Port 1, Port 2, and Port 3, and if the terminal uses Port 0 and Port 1 to send the same or related one stream of data, and the terminal uses Port 2 and Port 3 to send the same or related one stream of data, it can be understood that the terminal sends two layers of data. In embodiments of the present disclosure, the antenna capability can be described using one of “the stream of data” and “the layer of data”, as an example. The method can also be described using other manifestations of the antenna capability. In embodiments of the present disclosure, when describing “the antenna capability includes”, it can be replaced with “the antenna capability indicates”, and the meanings of the two expressions are equivalent.

In order to better understand the method for reporting a terminal capability, the apparatus thereof, and the storage medium provided in embodiments of the present disclosure, a communication system applicable to embodiments of the present disclosure will be described first in the following.

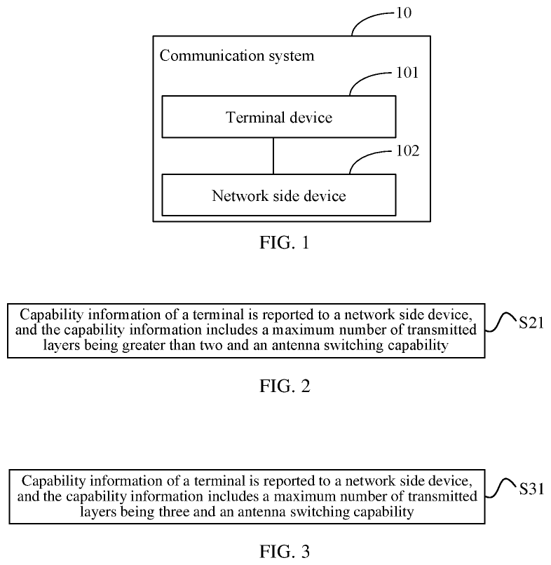

Reference is made to FIG. 1, which illustrates a schematic diagram of an architecture of a communication system 10 according to embodiments of the present disclosure. The communication system 10 can include, but is not limited to, one network side device and one terminal. The number and forms of devices shown in FIG. 1 are for example only and do not constitute a limitation on embodiments of the present disclosure. In practical applications, two or more network side devices and two or more terminals can be included. The communication system 10 shown in FIG. 1 includes a network side device 102 and a terminal device 101 as an example.

It should be noted that technical solutions provided in embodiments of the present disclosure can be applied to various communication systems, such as the Long Term Evolution (LTE) system, the 5th generation (5G) mobile communication system, the 5G new radio (NR) system, or other new mobile communication systems in the future.

The network side device 102 in embodiments of the present disclosure is an entity on the network side for transmitting or receiving signals. For example, the network side device 102 can be an evolved NodeB (eNB), a transmission reception point (TRP), a next generation NodeB (gNB) in the NR system, a base station in other future mobile communication systems, or an access node in wireless fidelity (WiFi) systems. Embodiments of the present disclosure do not limit the specific technology and device form adopted by the network side device. The network side device provided in embodiments of the present disclosure can include a central unit (CU) and a distributed unit (DU), and the CU can also be referred to as a control unit. The CU-DU structure can separate the network side device, for example, the protocol layer of the base station, with some protocol layer functions being placed in the CU under centralized control, and the remaining or all protocol layer functions being distributed in the DU, where DU is centrally controlled by CU.

The terminal device 101 in embodiments of the present disclosure is an entity on the user side for receiving or transmitting signals, such as a mobile phone. The terminal can also be referred to as a terminal device, user equipment (UE), a mobile station (MS), a mobile terminal (MT), etc. The terminal can include cars with communication capabilities, smart cars, mobile phones, wearable devices, Pads, computers with wireless transmission and reception capabilities, virtual reality (VR) terminals, augmented reality (AR) terminals, wireless terminals in industrial control, wireless terminals in self-driving, wireless terminals in remote medical surgery, wireless terminals in smart grid, wireless terminals in transportation safety, wireless terminals in smart city, and wireless terminals in smart home. Embodiments of the present disclosure do not limit the specific technology and device form adopted by the terminal.

It can be understood that the communication system described in embodiments of the present disclosure is intended to provide a clearer explanation of technical solutions in the present disclosure, and does not constitute a limitation on the present disclosure. Those of ordinary skill in the art can realize that with the evolution of the system architecture and the emergence of new business scenarios, the technical solutions provided in the embodiments of the present disclosure are also applicable to similar technical problems.

The method for reporting a terminal capability, the apparatus thereof and the storage medium provided by the present disclosure will be introduced in the following in detail in conjunction with the drawings.

Reference is made to FIG. 2, which illustrates a flowchart of a method for reporting a terminal capability according to embodiments of the present disclosure.

As shown in FIG. 2, the method is performed by a terminal, and the method can include but is not limited to the following steps.

In step S21, capability information of a terminal is reported to a network side device, and the capability information includes a maximum number of transmitted layers being greater than two and an antenna switching capability.

In some embodiments of the present disclosure, the terminal reports its capability information to the network side device before carrying out uplink transmission or when the terminal needs to re-report its antenna capability.

In some embodiments, the capability information reported by the terminal includes that the maximum number of transmitted layers is greater than two and the antenna switching capability.

It can be understood that the number of layers refers to the number of signal streams uncorrelated to each other contained in the data for sending when the data for sending is pre-coded. For example, if a terminal uses four antenna ports to send data, but sending the same or related data using these four antenna ports, it can be understood that the terminal uses these four antenna ports to send one stream of data, or in other words, sending one layer of data. For example, if the four antenna ports include Port 0, Port 1, Port 2, and Port 3, and if the terminal uses Port 0 and Port 1 to send the same or related one stream of data, and the terminal uses Port 2 and Port 3 to send the same or related one stream of data, it can be understood that the terminal sends two layers of data.

In the related technology, the terminal supports up to two RF transmission channels for uplink transmission. The network side device configures at least one SRS resource set for the terminal. After receiving the SRS resource set, the terminal sends SRS information to the network side device through up to two RF transmission channels on the corresponding port. The terminal supports the maximum number of two layers of data for uplink transmission, with a small amount of data for uplink transmission and poor application flexibility. In some embodiments of the present disclosure, the antenna capability reported by the terminal includes that the maximum number of transmitted layers is greater than two, allowing the terminal to send SRS information to the network side device through more than two RF transmission channels, thereby improving the uplink transmission capability, increasing the amount of data transmitted, and making the application of the terminal more flexible.

In some embodiments, the antenna capability reported by the terminal can also include other capability information besides the maximum number of transmitted layers of greater than two and the antenna switching capability. For example, the antenna capability can also include the number of antennas, etc. It should be noted that the above examples are only for illustrative purposes and are not intended to limit the present disclosure. Embodiments of the present disclosure do not place specific limitations on this.

According to embodiments of the present disclosure, the capability information of the terminal can be reported to network side device, and the capability information includes that the maximum number of transmitted layers is greater than two and the antenna switching capability. Therefore, the terminal supports reporting the capability information including the maximum number of transmitted layers greater than two and the antenna switching capability.

Reference is made to FIG. 3, which illustrates a flowchart of a method for reporting a terminal capability according to embodiments of the present disclosure.

As shown in FIG. 3, the method is performed by the terminal, and the method can include but is not limited to the following steps.

In step S31, capability information of a terminal is reported to a network side device, and the capability information includes a maximum number of transmitted layers being three and an antenna switching capability.

In some embodiments, the capability information reported by the terminal includes that the maximum number of transmitted layers is three and the antenna switching capability.

It can be understood that the number of layers refers to the number of signal streams uncorrelated to each other contained in the data for sending when the data for sending is pre-coded. For example, if a terminal uses four antenna ports to send data, but sending the same or related data using these four antenna ports, it can be understood that the terminal uses these four antenna ports to send one stream of data, or in other words, sending one layer of data. For example, if the four antenna ports include Port 0, Port 1, Port 2, and Port 3, and if the terminal uses Port 0 and Port 1 to send the same or related one stream of data, and the terminal uses Port 2 and Port 3 to send the same or related one stream of data, it can be understood that the terminal sends two layers of data.

In the related technology, the terminal supports up to two RF transmission channels for uplink transmission. The network side device configures at least one SRS resource set for the terminal. After receiving the SRS resource set, the terminal sends SRS information to the network side device through up to two RF transmission channels on the corresponding port. The terminal supports the maximum number of two layers of data for uplink transmission, with a small amount of data for uplink transmission and poor application flexibility. In some embodiments of the present disclosure, the antenna capability reported by the terminal includes that the maximum number of transmitted layers is three, allowing the terminal to send SRS information to the network side device through three RF transmission channels, thereby improving the uplink transmission capability, increasing the amount of data transmitted, and making the application of the terminal more flexible.

In some embodiments, the antenna capability reported by the terminal can also include other capability information besides the maximum number of transmitted layers of three and the antenna switching capability. For example, the antenna capability can also include the number of antennas, etc. It should be noted that the above examples are only for illustrative purposes and are not intended to limit the present disclosure. Embodiments of the present disclosure do not place specific limitations on this.

According to embodiments of the present disclosure, the capability information of the terminal can be reported to network side device, and the capability information includes that the maximum number of transmitted layers is three and the antenna switching capability. Therefore, the terminal supports reporting the capability information including the maximum number of transmitted layers of three and the antenna switching capability.

In some embodiments, the capability information also includes a maximum number of received layers being four 4R, or a maximum number of received layers being six, 6R, or a maximum number of received layers being eight, 8R.

It can be understood that the maximum number of received layers is four (4R) indicates that the terminal has the ability to receive up to four layers of data, the maximum number of received layers is six (6R) indicates that the terminal has the ability to receive up to six layers of data, and the maximum number of received layers is eight (8R) indicates that the terminal has the ability to receive up to eight layers of data.

In some embodiments of the present disclosure, the capability information reported by the terminal includes the maximum number of transmitted layers being three (3T) and the maximum number of received layers being four (4R), which is referred to as 3T4R; or the maximum number of transmitted layers being three (3T) and the maximum number of received layers being six (6R), which is referred to as 3T6R; or the maximum number of transmitted layers being three (3T) and the maximum number of received layers being eight (8R), which is referred to as 3T8R, to inform the network side device of the capability information of the terminal, so that the network side device can configure the corresponding SRS resource set based on the capability information reported by the terminal.

In some embodiments, a switching principle of the antenna switching capability includes uplink switching, downlink switching, or uplink and downlink switching. In some embodiments, the uplink switching refers to dynamic switching of a transmitting antenna or port, the downlink switching refers to dynamic switching of a receiving antenna or port, and the uplink and downlink switching refers to dynamic switching of transmitting and receiving antennas or ports.

In some embodiments of the present disclosure, the transmitting antenna or port dynamically switches (Tx switching), while the receiving antenna or port remains unchanged. For example, switching from xTyR to zTyR, where x is not equal to z, and x, y, and z are positive integers greater than 0, respectively. For example, the terminal switches from 4T4R to 2T4R or 1T4R.

In some embodiments of the present disclosure, the receiving antenna or port dynamically switches (Rx switching), while the transmitting antenna or port remains unchanged. For example, switching from xTyR to xTzR, where x is not equal to z, and x, y, and z are positive integers greater than 0, respectively. For example, the terminal switches from 1T4R to 1T2R or 1T1R.

In some embodiments of the present disclosure, the transmitting and receiving antennas or ports dynamically switch (Tx/Rx switching), while dynamic switching of the transmitting and receiving antennas or ports is supported. For example, switching from xTyR to x′Ty′R, which allows x and y to be not equal to x′, y′ simultaneously, where x, y, and x′, y′ are positive integers greater than 0, respectively. For example, the terminal switches from 4T4R to 1T2R or 1T1R.

In some embodiments of the present disclosure, where the capability information reported by the terminal includes 3T4R, operation modes supported by the terminal include: the maximum number of transmitted layers being one (1T) and the maximum number of received layers being one (1R), namely 1T1R; the maximum number of transmitted layers being one (1T) and the maximum number of received layers being two (2R), namely 1T2R; the maximum number of transmitted layers being one (1T) and the maximum number of received layers being four (4R), namely 1T4R; the maximum number of transmitted layers being two (2T) and the maximum number of received layers being two (2R), namely 2T2R; the maximum number of transmitted layers being two (2T) and the maximum number of received layers being four (4R), namely 2T4R; the maximum number of transmitted layers being three (3T) and the maximum number of received layers being four (4R), namely 3T4R.

It can be understood that in the case where the capability information reported by the terminal includes 3T4R, the operation modes supported by the terminal can include multiple types, such as 1T1R, 1T2R, 1T4R, 2T2R, and 3T4R. The terminal can operate in any of the above operation modes, or switch freely among different operation modes.

In some embodiments, the terminal of 3T4R can report its antenna switching capability while reporting the capability information of the terminal.

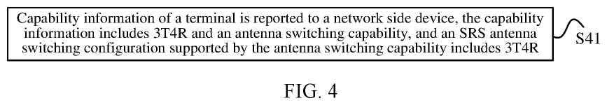

Reference is made to FIG. 4, which illustrates a flowchart of a method for reporting a terminal capability according to embodiments of the present disclosure.

As shown in FIG. 4, the method is performed by a terminal, and the method can include but is not limited to the following steps.

In step S41, capability information of a terminal is reported to a network side device, the capability information includes 3T4R and an antenna switching capability, and an SRS antenna switching configuration supported by the antenna switching capability includes 3T4R.

In some embodiments of the present disclosure, the SRS antenna switching configuration (supportedSRS-TxPortSwitch) supported by the antenna switching capability reported by the terminal includes 3T4R. It can be understood that the terminal reports to the network side device that it can only operate in 3T4R, and no other operation modes existed for the terminal to switch.

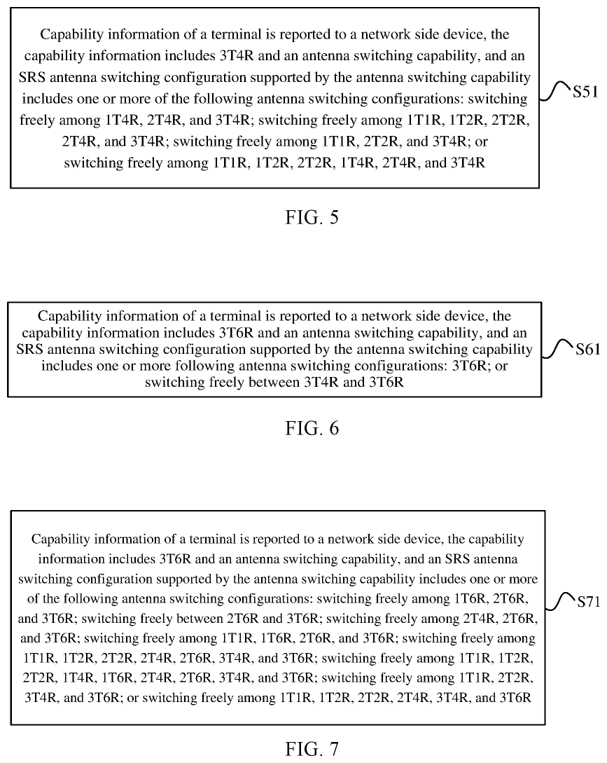

Reference is made to FIG. 5, which illustrates a flowchart of a method for reporting a terminal capability according to embodiments of the present disclosure.

As shown in FIG. 5, the method is performed by a terminal, and the method can include but is not limited to the following steps.

In step S51, capability information of a terminal is reported to a network side device, the capability information includes 3T4R and an antenna switching capability, and an SRS antenna switching configuration supported by the antenna switching capability includes one or more of the following antenna switching configurations:
switching freely among 1T4R, 2T4R, and 3T4R;
switching freely among 1T1R, 1T2R, 2T2R, 2T4R, and 3T4R;
switching freely among 1T1R, 2T2R, and 3T4R; or
switching freely among 1T1R, 1T2R, 2T2R, 1T4R, 2T4R, and 3T4R.

In some embodiments, the capability information reported by the terminal includes 3T4R, and the supported antenna switching capability supportedSRS-TxPortSwitch includes switching freely among 1T4R, 2T4R, and 3T4R. It can be understood that the operation modes reported by the terminal to the network side device can switch freely among 1T4R, 2T4R, and 3T4R.

In some embodiments, the capability information reported by the terminal includes 3T4R, and the supported antenna switching capability supportedSRS-TxPortSwitch includes switching freely among 1T4R, 2T4R, and 3T4R, and switching freely among 1T1R, 1T2R, 2T2R, 2T4R and 3T4R. It can be understood that the operation modes reported by the terminal to the network side device can switch freely among 1T4R, 2T4R, 3T4R, 1T1R, 1T2R, and 2T2R.

It should be noted that the above examples are only for illustrative purposes and are not intended to limit the present disclosure. In embodiments of the present disclosure, the antenna switching capability reported by the terminal can also include other modes. Embodiments of the present disclosure do not place specific limitations on this.

In some embodiments of the present disclosure, where the capability information includes 3T6R, operation modes supported by the terminal include: the maximum number of transmitted layers being one (1T) and the maximum number of received layers being one (1R), namely 1T1R; the maximum number of transmitted layers being one (1T) and the maximum number of received layers being two (2R), namely 1T2R; the maximum number of transmitted layers being one (1T) and the maximum number of received layers being four (4R), namely 1T4R; the maximum number of transmitted layers being one (1T) and the maximum number of received layers being six (6R), namely 1T6R; the maximum number of transmitted layers being two (2T) and the maximum number of received layers being two (2R), namely 2T2R; the maximum number of transmitted layers being two (2T) and the maximum number of received layers being four (4R), namely 2T4R; the maximum number of transmitted layers being two (2T) and the maximum number of received layers being six (6R), namely 2T6R; the maximum number of transmitted layers being three (3T) and the maximum number of received layers being four (4R), namely 3T4R; the maximum number of transmitted layers being three (3T) and the maximum number of received layers being six (6R), namely 3T6R.

It can be understood that in the case where the capability information reported by the terminal includes 3T6R, the operation modes supported by the terminal can include multiple types. The terminal can operate in any of the above operation modes, or switch freely among different operation modes.

In some embodiments, the terminal of 3T6R can report its antenna switching capability while reporting the capability information of the terminal.

Reference is made to FIG. 6, which illustrates a flowchart of a method for reporting a terminal capability according to embodiments of the present disclosure.

As shown in FIG. 6, the method is performed by a terminal, and the method can include but is not limited to the following steps.

In step S61, capability information of a terminal is reported to a network side device, the capability information includes 3T6R and an antenna switching capability, and an SRS antenna switching configuration supported by the antenna switching capability includes one or more following antenna switching configurations:
3T6R; or
switching freely between 3T4R and 3T6R.

In some embodiments, the capability information reported by the terminal includes 3T6R, and the supportedSRS-TxPortSwitch supported by the antenna switching capability includes 3T6R. It can be understood that the terminal reports to the network side device that its operation mode is 3T6R, and no other operation modes existed for the terminal to switch.

In some embodiment, the capability information reported by the terminal includes 3T6R, and the supportedSRS-TxPortSwitch supported by the antenna switching capability includes 3T6R, and switching freely between 3T4R and 3T6R. It can be understood that the operation modes reported by the terminal to the network side device can switch freely between 3T4R and 3T6R.

It should be noted that the above examples are only for illustrative purposes and are not intended to limit the present disclosure. In embodiments of the present disclosure, the antenna switching capability reported by the terminal can also include other modes. Embodiments of the present disclosure do not place specific limitations on this.

Reference is made to FIG. 7, which illustrates a flowchart of a method for reporting a terminal capability according to embodiments of the present disclosure.

As shown in FIG. 7, the method is performed by a terminal, and the method can include but is not limited to the following steps.

In step S71, capability information of a terminal is reported to a network side device, the capability information includes 3T6R and an antenna switching capability, and an SRS antenna switching configuration supported by the antenna switching capability includes one or more of the following antenna switching configurations:
switching freely among 1T6R, 2T6R, and 3T6R;
switching freely between 2T6R and 3T6R;
switching freely among 2T4R, 2T6R, and 3T6R;
switching freely among 1T1R, 1T6R, 2T6R, and 3T6R;
switching freely among 1T1R, 1T2R, 2T2R, 2T4R, 2T6R, 3T4R, and 3T6R;
switching freely among 1T1R, 1T2R, 2T2R, 1T4R, 1T6R, 2T4R, 2T6R, 3T4R, and 3T6R;
switching freely among 1T1R, 2T2R, 3T4R, and 3T6R; or
switching freely among 1T1R, 1T2R, 2T2R, 2T4R, 3T4R, and 3T6R.

In some embodiments, the capability information reported by the terminal includes 3T6R, and the supported antenna switching capability supportedSRS-TxPortSwitch includes switching freely among 1T6R, 2T6R, and 3T6R. It can be understood that the operation modes reported by the terminal to the network side device can switch freely among 1T6R, 2T6R, and 3T6R.

In some embodiment, the capability information reported by the terminal includes 3T6R, and the supported antenna switching capability supportedSRS-TxPortSwitch includes switching freely among 1T6R, 2T6R, and 3T6R, and switching freely between 2T6R and 3T6R. It can be understood that the operation modes reported by the terminal to the network side device can be switch freely among 1T6R, 2T6R, and 3T6R.

It should be noted that the above examples are only for illustrative purposes and are not intended to limit the present disclosure. In embodiments of the present disclosure, the antenna switching capability reported by the terminal can also include other modes. Embodiments of the present disclosure do not place specific limitations on this.

In some embodiments of the present disclosure, where the capability information includes 3T8R, operation modes supported by the terminal include: the maximum number of transmitted layers being one (1T) and the maximum number of received layers being one (1R), namely 1T1R; the maximum number of transmitted layers being one (1T) and the maximum number of received layers being two (2R), namely 1T2R; the maximum number of transmitted layers being one (1T) and the maximum number of received layers being four (4R), namely 1T4R; the maximum number of transmitted layers being one (1T) and the maximum number of received layers being six (5R), namely 1T6R; the maximum number of transmitted layers being one (1T) and the maximum number of received layers being eight (8R), namely 1T8R; the maximum number of transmitted layers being two (2T) and the maximum number of received layers being two (2R), namely 2T2R; the maximum number of transmitted layers being two (2T) and the maximum number of received layers being four (4R), namely 2T4R; the maximum number of transmitted layers being two (2T) and the maximum number of received layers being six (6R), namely 2T6R; the maximum number of transmitted layers being two (2T) and the maximum number of received layers being eight (8R), namely 2T8R; the maximum number of transmitted layers being three (3T) and the maximum number of received layers being four (4R), namely 3T4R; the maximum number of transmitted layers being three (3T) and the maximum number of received layers being six (6R), namely 3T6R; the maximum number of transmitted layers being three (3T) and the maximum number of received layers being eight (8R), namely 3T8R.

It can be understood that in the case where the capability information reported by the terminal includes 3T8R, the operation modes supported by the terminal can include multiple types. The terminal can operate in any of the above operation modes, or switch freely among different operation modes.

In some embodiments, the terminal of 3T8R can report its antenna switching capability while reporting the capability information of the terminal.

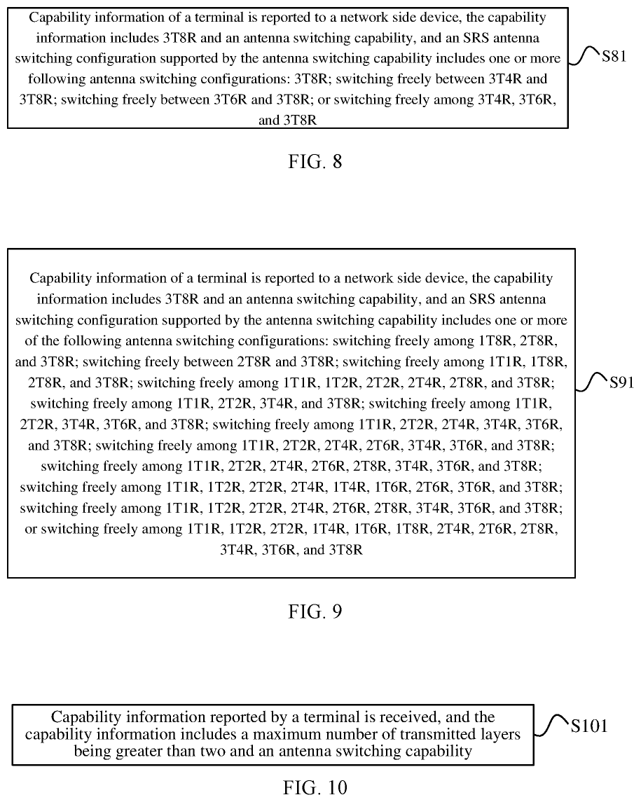

Reference is made to FIG. 8, which illustrates a flowchart of a method for reporting a terminal capability according to embodiments of the present disclosure.

As shown in FIG. 8, the method is performed by a terminal, and the method can include but is not limited to the following steps.

In step S81, capability information of a terminal is reported to a network side device, the capability information includes 3T8R and an antenna switching capability, and an SRS antenna switching configuration supported by the antenna switching capability includes one or more following antenna switching configurations:
3T8R;
switching freely between 3T4R and 3T8R;
switching freely between 3T6R and 3T8R; or

switching freely among 3T4R, 3T6R, and 3T8R.

In some embodiments, the capability information reported by the terminal includes 3T8R, and the supportedSRS-TxPortSwitch supported by the antenna switching capability includes 3T8R. It can be understood that the terminal reports to the network side device that its operation mode is 3T8R, and no other operation modes existed for the terminal to switch.

In some embodiment, the capability information reported by the terminal includes 3T8R, and the supportedSRS-TxPortSwitch supported by the antenna switching capability includes 3T8R, and switching freely between 3T4R and 3T8R. It can be understood that the operation modes reported by the terminal to the network side device can switch freely between 3T4R and 3T8R.

It should be noted that the above examples are only for illustrative purposes and are not intended to limit the present disclosure. In embodiments of the present disclosure, the antenna switching capability reported by the terminal can also include other modes. Embodiments of the present disclosure do not place specific limitations on this.

Reference is made to FIG. 9, which illustrates a flowchart of a method for reporting a terminal capability according to embodiments of the present disclosure.

As shown in FIG. 9, the method is performed by a terminal, and the method can include but is not limited to the following steps.

In step S91, capability information of a terminal is reported to a network side device, the capability information includes 3T8R and an antenna switching capability, and an SRS antenna switching configuration supported by the antenna switching capability includes one or more of the following antenna switching configurations:
switching freely among 1T8R, 2T8R, and 3T8R;
switching freely between 2T8R and 3T8R;
switching freely among 1T1R, 1T8R, 2T8R, and 3T8R;
switching freely among 1T1R, 1T2R, 2T2R, 2T4R, 2T8R, and 3T8R;
switching freely among 1T1R, 2T2R, 3T4R, and 3T8R;
switching freely among 1T1R, 2T2R, 3T4R, 3T6R, and 3T8R;
switching freely among 1T1R, 2T2R, 2T4R, 3T4R, 3T6R, and 3T8R;
switching freely among 1T1R, 2T2R, 2T4R, 2T6R, 3T4R, 3T6R, and 3T8R;
switching freely among 1T1R, 2T2R, 2T4R, 2T6R, 2T8R, 3T4R, 3T6R, and 3T8R;
switching freely among 1T1R, 1T2R, 2T2R, 2T4R, 1T4R, 1T6R, 2T6R, 3T6R, and 3T8R;
switching freely among 1T1R, 1T2R, 2T2R, 2T4R, 2T6R, 2T8R, 3T4R, 3T6R, and 3T8R; or
switching freely among 1T1R, 1T2R, 2T2R, 1T4R, 1T6R, 1T8R, 2T4R, 2T6R, 2T8R, 3T4R, 3T6R, and 3T8R.

In some embodiments, the capability information reported by the terminal includes 3T8R, and the supported antenna switching capability supportedSRS-TxPortSwitch includes switching freely among 1T8R, 2T8R, and 3T8R. It can be understood that the operation modes reported by the terminal to the network side device can switch freely among 1T8R, 2T8R, and 3T8R.

In some embodiment, the capability information reported by the terminal includes 3T8R, and the supported antenna switching capability supportedSRS-TxPortSwitch includes switching freely among 1T8R, 2T8R, and 3T8R, and switching freely among 1T1R, 1T8R, 2T8R, and 3T8R. It can be understood that the operation modes reported by the terminal to the network side device can be switch freely among 1T1R, 1T8R, 2T8R, and 3T8R.

It should be noted that the above examples are only for illustrative purposes and are not intended to limit the present disclosure. In embodiments of the present disclosure, the antenna switching capability reported by the terminal can also include other modes. Embodiments of the present disclosure do not place specific limitations on this.

Reference is made to FIG. 10, which illustrates a flowchart of a method for reporting a terminal capability according to embodiments of the present disclosure.

As shown in FIG. 10, the method is performed by a network side device, and the method can include but is not limited to the following steps.

In step S101, capability information reported by a terminal is received, and the capability information includes a maximum number of transmitted layers being greater than two and an antenna switching capability.

In some embodiments of the present disclosure, the terminal reports its capability information to the network side device before carrying out uplink transmission or when the terminal needs to re-report its antenna capability.

In some embodiments, the capability information reported by the terminal includes that the maximum number of transmitted layers is greater than two and the antenna switching capability.

It can be understood that the number of layers refers to the number of signal streams uncorrelated to each other contained in the data for sending when the data for sending is pre-coded. For example, if a terminal uses four antenna ports to send data, but sending the same or related data using these four antenna ports, it can be understood that the terminal uses these four antenna ports to send one stream of data, or in other words, sending one layer of data. For example, if the four antenna ports include Port 0, Port 1, Port 2, and Port 3, and if the terminal uses Port 0 and Port 1 to send the same or related one stream of data, and the terminal uses Port 2 and Port 3 to send the same or related one stream of data, it can be understood that the terminal sends two layers of data.

In the related technology, the terminal supports up to two RF transmission channels for uplink transmission. The network side device configures at least one SRS resource set for the terminal. After receiving the SRS resource set, the terminal sends SRS information to the network side device through up to two RF transmission channels on the corresponding port. The terminal supports the maximum number of two layers of data for uplink transmission, with a small amount of data for uplink transmission and poor application flexibility. In some embodiments of the present disclosure, the antenna capability reported by the terminal includes that the maximum number of transmitted layers is greater than two, allowing the terminal to send SRS information to the network side device through more than two RF transmission channels, thereby improving the uplink transmission capability, increasing the amount of data transmitted, and making the application of the terminal more flexible.

In some embodiments, the antenna capability reported by the terminal can also include other capability information besides the maximum number of transmitted layers of greater than two and the antenna switching capability. For example, the antenna capability can also include the number of antennas, etc. It should be noted that the above examples are only for illustrative purposes and are not intended to limit the present disclosure. Embodiments of the present disclosure do not place specific limitations on this.

According to embodiments of the present disclosure, the terminal reports its capability information to the network side device, and the capability information includes that the maximum number of transmitted layers is greater than two and the antenna switching capability. Therefore, the terminal supports reporting the capability information including the maximum number of transmitted layers greater than two and the antenna switching capability.

The methods provided in embodiments of the present disclosure are introduced from the network side device side and the terminal side. In order to achieve the various functions of the methods provided in embodiments of the present disclosure, the network side device and the terminal can include hardware structures and software modules, which are implemented in the form of hardware structures, software modules, or the hardware structures and the software modules. One of the above functions can be achieved in the form of hardware structures, software modules, or the hardware structures and the software modules.

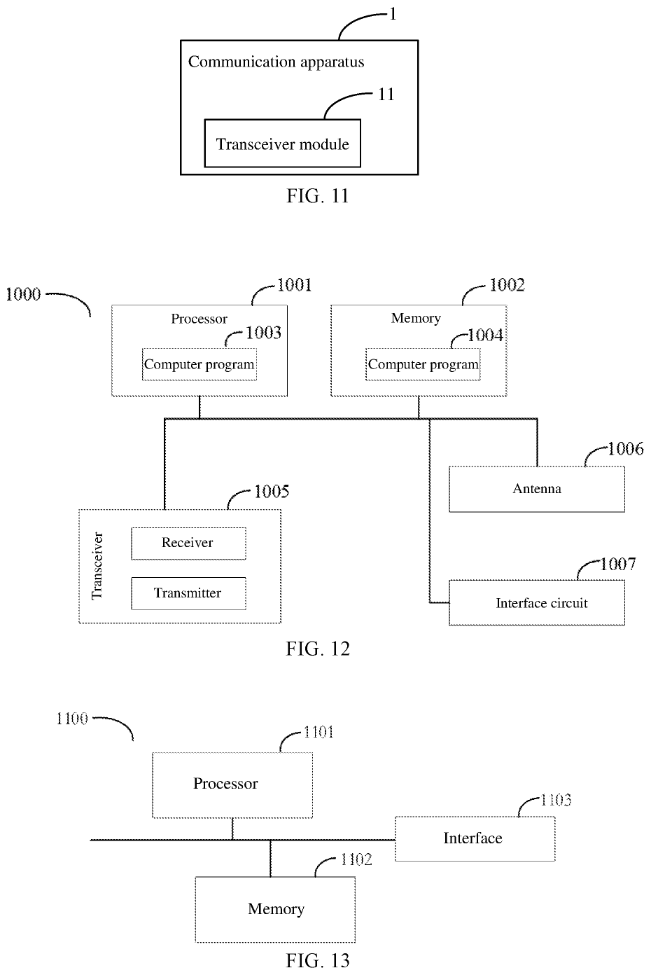

Reference is made to FIG. 11, which illustrates a diagram of a structure of a communication apparatus 1 according to embodiments of the present disclosure. The communication apparatus 1 shown in FIG. 11 can include a transceiver module 11 and a processing module 12. The transceiver module 11 can include a sending module and/or a receiving module. The sending module is configured for implementing the sending function, the receiving module is configured for implementing the receiving function, and the transceiver module 11 can implement the sending and/or receiving function.

The communication apparatus 1 can be a terminal, or an apparatus within the terminal, or an apparatus that can be matched and operated with the terminal. Alternatively, communication apparatus 1 can be a network side device, or an apparatus within the network side device, or an apparatus that can be matched and operated with the network side device.

In some embodiments of the present disclosure, the communication apparatus 1 is a terminal, and the apparatus includes a transceiver module 11 configured to report capability information of the terminal to a network side device. In some embodiments, the capability information includes a maximum number of transmitted layers being greater than two and an antenna switching capability.

In some embodiments of the present disclosure, the communication apparatus 1 is a network side device, and the apparatus includes a transceiver module 11 configured to receive capability information reported by the terminal. In some embodiments, the capability information includes a maximum number of transmitted layers being greater than two and an antenna switching capability.

Regarding the communication apparatus 1 in the above embodiments, the specific ways in which each module performs operations have been described in detail in relevant method embodiments, which will not be elaborated here. The communication apparatus 1 provided in the above embodiments can achieve the same or similar beneficial effects as described with respect to the methods for reporting the terminal capability provided in the method embodiments, which will not be repeated here.

Reference is made to FIG. 12, which illustrates a schematic diagram of a structure of a communication device 1000 according to embodiments of the present disclosure. The communication device 1000 can be a network side device, a terminal, a chip, a chip system, or a processor that supports the network side device to implement the above methods, and the communication device 1000 can also be a chip, a chip system, or a processor that supports the terminal to implement the above methods. The communication device 1000 can be used to implement the methods described in the above method embodiments. Specifically, reference can be made to the description in the above method embodiments.

The communication device 1000 can be a network side device, a terminal, a chip, a chip system, or a processor that supports the network side device to implement the above methods, and the communication device 1000 can also be a chip, a chip system, or a processor that supports the terminal to implement the above methods. The communication device 1000 can be used to implement the methods described in the above method embodiments. Specifically, reference can be made to the description in the above method embodiments.

The communication device 1000 can include one or more processors 1001. The processor 1001 can be a general-purpose processor or a dedicated processor, etc. For example, the processor can be a baseband processor or a central processor. The baseband processor can be used to process communication protocols and communication data, and the central processor can be used to control the communication device (such as base stations, baseband chips, terminals, terminal chips, DU or CU, etc.), execute computer programs, and process computer program data.

In some embodiments, the communication device 1000 can also include one or more memories 1002, and a computer program 1004 can be stored on the memory. The processor 1001 can execute the computer program 1004 to cause the communication device 1000 to implement the methods described in the above embodiments. In some embodiments, the memory 1002 can also store data. The communication device 1000 and the memory 1002 can be arranged separately or integrated together.

In some embodiments, the communication device 1000 can also include a transceiver 1005 and an antenna 1006. The transceiver 1005 can be referred to as a transceiver unit, a transceiver machine, or a transceiver circuit, etc., and can be used to achieve a transceiving function. The transceiver 1005 can include a receiver and a transmitter. The receiver can be referred to as a receiver or a receiver circuit, etc., and is used to achieve a receiving function. The transmitter can be referred to as a transmitter or a transmitter circuit, etc., and is used to achieve a transmitting function.

In some embodiments, the communication device 1000 can also include one or more interface circuits 1007. The interface circuit 1007 is used to receive code instructions and transmit the code instructions to the processor 1001. The processor 1001 executes the code instructions to cause the communication device 1000 to implement the methods described in the above method embodiments.

The communication device 1000 is a terminal, and the transceiver 1005 is used to execute steps S21 in FIG. 2, S31 in FIG. 3, S41 in FIG. 4, S51 in FIG. 5, S61 in FIG. 6, S71 in FIG. 7, S81 in FIG. 8, and S91 in FIG. 9.

The communication device 1000 is a network side device, and the transceiver 1005 is used to execute the step S101 in FIG. 10.

In some embodiments, the processor 1001 can include a transceiver for achieving receiving and transmitting functions. For example, the transceiver can be a transceiver circuit, an interface, or an interface circuit. The transceiver circuit, interface, or interface circuit used to achieve receiving and transmitting functions can be separate or integrated together. The above-mentioned transceiver circuit, interface or interface circuit can be used for reading and writing codes/data, or the above-mentioned transceiver circuit, interface or interface circuit can be used for transmitting or transferring signals.

In some embodiments, the processor 1001 can store a computer program 1003, which runs on the processor 1001 and causes the communication device 1000 to implement the methods described in the above embodiments. The computer program 1003 can be embedded in processor 1001, in which case the processor 1001 can be realized through hardware.

In some embodiments, the communication device 1000 can include a circuit that can achieve receiving, transmitting, or communicating functions as described in the above method embodiments. The processor and the transceiver described in the present disclosure can be realized on the integrated circuit (IC), analog IC, radio frequency integrated circuit (RFIC), mixed signal IC, application specific integrated circuit (ASIC), printed circuit board (PCB), electronic device, and the like. The processor and the transceiver can also be manufactured using various IC process technologies, such as complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon germanium (SiGe), gallium arsenide (GaAs), etc.

The communication device described in the above embodiments can be a terminal, but the communication device described in the present disclosure is not limited to this, and the structure of the communication device may not be limited by FIG. 12. The communication device can be an independent device or can be part of a larger device. For example, the communication device can be at least one of:

(1) Independent integrated circuit ICs, or chips, or chip systems or subsystems.

(2) A set including one or more ICs, which can optionally also include storage components for storing data and computer programs.

(3) ASICs, for example, a modem.

(4) Modules that can be embedded in other devices.

(5) Receivers, terminals, intelligent terminals, cellular phones, wireless devices, handheld devices, mobile units, vehicle mounted devices, network side devices, cloud devices, artificial intelligence devices, etc.

(6) Other devices and so on.

For the case where the communication device can be a chip or a chip system, reference is made to FIG. 13, which illustrates a schematic diagram of a structure of a chip according to embodiments of the present disclosure.

The chip 1100 includes a processor 1101 and an interface 1103. In some embodiments, the number of processors 1101 can be one or more, and the number of interfaces 1103 can be multiple.

For the case where the chip is used to achieve the functions of the terminal in some embodiments of the present disclosure, the interface 1103 is configured to receive code instructions and transmitting the code instructions to the processor, and the processor 1101 is configured to run the code instructions to implement the methods for reporting the terminal capability as described in some embodiments above.

For the case where the chip is used to achieve the functions of the network side device in some embodiments of the present disclosure, the interface 1103 is configured to receive code instructions and transmitting the code instructions to the processor, and the processor 1101 is configured to run the code instructions to implement the methods for reporting the terminal capability as described in some embodiments above.

In some embodiments, the chip 1100 further includes a memory 1102, which is used for storing necessary computer programs and data.

Those skilled in the art can also understand that the various illustrative logical blocks and steps listed in the embodiments of the present disclosure can be achieved through electronic hardware, computer software, or a combination of both. Whether a function is achieved through hardware or software depends on the specific application and design requirements of the overall system. Those skilled in the art can use various methods to achieve the described functions for each specific application, but such achievement should not be understood as beyond the protection scope of the present disclosure.

Embodiments of the present disclosure also provide a system for reporting a terminal capability, which includes a communication apparatus serving as a network side device and a communication apparatus serving as a terminal in embodiments of FIG. 11, or a communication device serving as a network side device and a communication device serving as a terminal in embodiments of FIG. 12.

The present disclosure also provides a readable storage medium on which instructions are stored, and when the instructions are executed by a computer, the functions of any of the above method embodiments are achieved.

The present disclosure also provides a computer program product that achieves the functions of any of the above method embodiments when executed by a computer.

The above embodiments can be fully or partially implemented through software, hardware, firmware, or any combination thereof. When implemented using software, the embodiments can be fully or partially implemented in the form of a computer program product. The computer program product includes one or more computer programs. When the computer programs are loaded and executed on the computer, all or part of the processes or functions described in the embodiments of the present disclosure are generated. The computer can be a general-purpose computer, a dedicated computer, a computer network, or other programmable devices. The computer program can be stored in a non-transitory computer-readable storage medium or transmitted from one non-transitory computer-readable storage medium to another. For example, the computer program can be transmitted from a website site, a computer, a server, or a data center via wired (such as coaxial cable, optical fiber, digital subscriber line (DSL)) or wireless (such as infrared, wireless, microwave, etc.) communication, to transmit to another website, computer, server, or data center. The non-transitory computer-readable storage medium can be any available medium that the computer can access, or a data storage device such as a server, a data center, etc. that integrates one or more available media. The available media can be magnetic media (such as floppy disks, hard drives, magnetic tapes), optical media (such as high-density digital video discs (DVDs)), or semiconductor media (such as solid state disks (SSDs)), etc.

Those of ordinary skill in the art can understand that the first, second, and other numerical numbers involved in the present disclosure are only for the convenience of description and differentiation, and are not used to limit the scope of embodiments of the present disclosure, but also indicate an order.

At least one in the present disclosure can also be described as one or more, where more can be two, three, four, or more, which is not limited in the present disclosure. In embodiments of the present disclosure, “first”, “second”, “third”, “A”, “B”, “C”, and “D” can be used to distinguish different technical features described, and the technical features described using “first”, “second”, “third”, “A”, “B”, “C”, and “D” are not distinguished from each other in an order or a magnitude.

The corresponding relationships shown in each table in the present disclosure can be configured or predefined. The values of the information in each table are only examples and can be configured to other values, which is not limited in the present disclosure. When configuring the correspondence between information and various parameters, it is not necessary to configure all the correspondence shown in each table. For example, in the table of the present disclosure, the correspondence shown in certain rows may not be configured. For example, appropriate deformation adjustments can be made based on the above table, such as splitting, merging, etc. The names of the parameters shown in the titles of the above tables can also use other names that can be understood by the communication device, and the values or representations of the parameters can also use other values or representations that can be understood by the communication device. When implementing the above tables, other data structures can also be used, such as arrays, queues, containers, stacks, linear tables, pointers, linked lists, trees, graphs, structures, classes, heaps, hash tables, etc.

The term predefined in the present disclosure can be understood as defined, defined in advance, stored, stored in advance, negotiated in advance, configured in advance, solidified in advance, or fired in advance.

Those of ordinary skill in the art can realize that units and algorithm steps of each example described in embodiments of the present disclosure can be implemented in electronic hardware, or a combination of computer software and electronic hardware. Whether these functions are implemented in hardware or software depends on the specific application and design constraints of the technical solution. The skilled person can use different methods to achieve the described functions for each specific application, but such achievement should not be considered as beyond the scope of the present disclosure.

Those skilled in the art can clearly understand that for the convenience and conciseness of the description, the specific working processes of the system, device, and unit described above can refer to the corresponding processes in the above method embodiments, which will not be repeated here.

The above are only specific implementations of the present disclosure, but the protection scope of the present disclosure is not limited to this. Those changes or replacements that can be easily conceived by any skilled person familiar with the technical field within the scope of the present disclosure, should be within the protection scope of the present disclosure. Therefore, the protection scope of the present disclosure should be based on the protection scope of appended claims.

1. A method for reporting a terminal capability, performed by a terminal, the method comprising:
reporting capability information of the terminal to a network side device, wherein the capability information comprises a maximum number of transmitted layers being greater than two and an antenna switching capability.

2. The method according to claim 1, wherein the capability information comprises the maximum number of transmitted layers being three (3T).

3. The method according to claim 2, wherein the capability information further comprises a maximum number of received layers being four (4R), or the maximum number of received layers being six (6R), or the maximum number of received layers being eight (8R).

4. The method according to claim 1, wherein a switching principle of the antenna switching capability comprises uplink switching, downlink switching, or uplink and downlink switching, and wherein the uplink switching comprises dynamic switching of a transmitting antenna or port, the downlink switching comprises dynamic switching of a receiving antenna or port, and the uplink and downlink switching comprises dynamic switching of transmitting and receiving antennas or ports.

5. The method according to claim 3, wherein the capability information comprises 3T4R, and operation modes supported by the terminal comprise:
1T1R, where the maximum number of transmitted layers is one (1T) and the maximum number of received layers is one (1R);
1T2R, where the maximum number of transmitted layers is one (1T) and the maximum number of received layers is two (2R);
1T4R, where the maximum number of transmitted layers is one (1T) and the maximum number of received layers is four (4R);
2T2R, where the maximum number of transmitted layers is two (2T) and the maximum number of received layers is two (2R);
2T4R, where the maximum number of transmitted layers is two (2T) and the maximum number of received layers is four (4R); and
3T4R, where the maximum number of transmitted layers is three (3T) and the maximum number of received layers is four (4R).

6. The method according to claim 5, wherein an SRS antenna switching configuration supported by the antenna switching capability comprises 3T4R.

7. The method according to claim 5, wherein an SRS antenna switching configuration supported by the antenna switching capability comprises one or more of following configurations:
switching freely among 1T4R, 2T4R, and 3T4R;
switching freely among 1T1R, 1T2R, 2T2R, 2T4R, and 3T4R;
switching freely among 1T1R, 2T2R, and 3T4R; or
switching freely among 1T1R, 1T2R, 2T2R, 1T4R, 2T4R, and 3T4R.

8. The method according to claim 3, wherein the capability information comprises 3T6R, and operation modes supported by the terminal comprise:
1T1R, where the maximum number of transmitted layers is one (1T) and the maximum number of received layers is one (1R);
1T2R, where the maximum number of transmitted layers is one (1T) and the maximum number of received layers is two (2R);
1T4R, where the maximum number of transmitted layers is one (1T) and the maximum number of received layers is four (4R);
1T6R, where the maximum number of transmitted layers is one (1T) and the maximum number of received layers is six (6R);
2T2R, where the maximum number of transmitted layers is two (2T) and the maximum number of received layers is two (2R);
2T4R, where the maximum number of transmitted layers is two (2T) and the maximum number of received layers is four (4R);
2T6R, where the maximum number of transmitted layers is two (2T) and the maximum number of received layers is six (6R);
3T4R, where the maximum number of transmitted layers is three (3T) and the maximum number of received layers is four (4R); and
3T6R, where the maximum number of transmitted layers is three (3T) and the maximum number of received layers is six (6R).

9. The method according to claim 8, wherein the capability information comprises 3T6R, and an SRS antenna switching configuration supported by the antenna switching capability comprises one or more of following configurations:
3T6R; or
switching freely between 3T4R and 3T6R.

10. The method according to claim 8, wherein the capability information comprises 3T6R, and an SRS antenna switching configuration supported by the antenna switching capability comprises one or more of following configurations:
switching freely among 1T6R, 2T6R, and 3T6R;
switching freely between 2T6R and 3T6R;
switching freely among 2T4R, 2T6R, and 3T6R;
switching freely among 1T1R, 1T6R, 2T6R, and 3T6R;
switching freely among 1T1R, 1T2R, 2T2R, 2T4R, 2T6R, 3T4R, and 3T6R;
switching freely among 1T1R, 1T2R, 2T2R, 1T4R, 1T6R, 2T4R, 2T6R, 3T4R, and 3T6R;
switching freely among 1T1R, 2T2R, 3T4R, and 3T6R; or
switching freely among 1T1R, 1T2R, 2T2R, 2T4R, 3T4R, and 3T6R.

11. The method according to claim 3, wherein the capability information comprises 3T8R, and operation modes supported by the terminal comprise:
1T1R, where the maximum number of transmitted layers is one (1T) and the maximum number of received layers is one (1R);
1T2R, where the maximum number of transmitted layers is one (1T) and the maximum number of received layers is two (2R);
1T4R, where the maximum number of transmitted layers is one (1T) and the maximum number of received layers is four (4R);
1T6R, where the maximum number of transmitted layers is one (1T) and the maximum number of received layers is six (6R);
1T8R, where the maximum number of transmitted layers is one (1T) and the maximum number of received layers is eight (8R);
2T2R, where the maximum number of transmitted layers is two (2T) and the maximum number of received layers is two (2R);
2T4R, where the maximum number of transmitted layers is two (2T) and the maximum number of received layers is four (4R);
2T6R, where the maximum number of transmitted layers is two (2T) and the maximum number of received layers is six (6R);
2T8R, where the maximum number of transmitted layers is two (2T) and the maximum number of received layers is eight (8R);
3T4R, where the maximum number of transmitted layers is three (3T) and the maximum number of received layers is four (4R);
3T6R, where the maximum number of transmitted layers is three (3T) and the maximum number of received layers is six (6R); and
3T8R, where the maximum number of transmitted layers is three (3T) and the maximum number of received layers is eight (8R).

12. The method according to claim 11, wherein the capability information comprises 3T8R, and an SRS antenna switching configuration supported by the antenna switching capability comprises one or more of following configurations:
3T8R;
switching freely between 3T4R and 3T8R;
switching freely between 3T6R and 3T8R; or
switching freely among 3T4R, 3T6R, and 3T8R.

13. The method according to claim 11, wherein the capability information comprises 3T8R, and an SRS antenna switching configuration supported by the antenna switching capability comprises one or more of following configurations:
switching freely among 1T8R, 2T8R, and 3T8R;
switching freely between 2T8R and 3T8R;
switching freely among 1T1R, 1T8R, 2T8R, and 3T8R;
switching freely among 1T1R, 1T2R, 2T2R, 2T4R, 2T8R, and 3T8R;
switching freely among 1T1R, 2T2R, 3T4R, and 3T8R;
switching freely among 1T1R, 2T2R, 3T4R, 3T6R, and 3T8R;
switching freely among 1T1R, 2T2R, 2T4R, 3T4R, 3T6R, and 3T8R;
switching freely among 1T1R, 2T2R, 2T4R, 2T6R, 3T4R, 3T6R, and 3T8R;
switching freely among 1T1R, 2T2R, 2T4R, 2T6R, 2T8R, 3T4R, 3T6R, and 3T8R;
switching freely among 1T1R, 1T2R, 2T2R, 2T4R, 1T4R, 1T6R, 2T6R, 3T6R, and 3T8R;
switching freely among 1T1R, 1T2R, 2T2R, 2T4R, 2T6R, 2T8R, 3T4R, 3T6R, and 3T8R; or
switching freely among 1T1R, 1T2R, 2T2R, 1T4R, 1T6R, 1T8R, 2T4R, 2T6R, 2T8R, 3T4R, 3T6R, and 3T8R.

14. A method for reporting a terminal capability, performed by a network side device, the method comprising:
receiving capability information reported by a terminal, wherein the capability information comprises a maximum number of transmitted layers being greater than two and an antenna switching capability.

15. (canceled)

16. (canceled)

17. A communication device, comprising:
a processor; and
a memory storing a computer program executable by the processor;
wherein the processor is configured to:
report capability information of a terminal to a network side device, wherein the capability information comprises a maximum number of transmitted layers being greater than two and an antenna switching capability.

18. A communication device, comprising:
a processor; and
a memory storing a computer program executable by the processor;
wherein the processor is configured to perform the method according to claim 14.

19. A communication device, comprising:
a processor; and
an interface circuit,
wherein the interface circuit is configured to receive code instructions and transmit the code instructions to the processor; and
the processor is configured to run the code instructions to cause the method according to claim 1 to be implemented.

20. A communication device, comprising:
a processor; and
an interface circuit,
wherein the interface circuit is configured to receive code instructions and transmit the code instructions to the processor; and
the processor is configured to run the code instructions to cause the method according to claim 14 to be implemented.

21. A non-transitory computer-readable storage medium for storing instructions, which when executed cause the method according to claim 1 to be implemented.

22. A non-transitory computer-readable storage medium for storing instructions, which when executed cause the method according to claim 14 to be implemented.
